(19) United States
(12) Patent Application Publication
(10) Pub. No.: US 2014/0278803 A1
(43) Pub. Date: Sep. 18, 2014

(54) System and Method for Estimating Price Sensitivity and/or Price Aggregation for a Population Having a Collection of Items

(71) Applicant: Opera Solutions, LLC, Jersey City, NJ (US)

(72) Inventors: Vesselin Diev, San Diego, CA (US); Shamima Huq, San Diego, CA (US)

(73) Assignee: Opera Solutions, LLC, Jersey City, NJ (US)

(21) Appl. No.: 14/206,677

(22) Filed: Mar. 12, 2014

Related U.S. Application Data
(60) Provisional application No. 61/779,717, filed on Mar. 13, 2013.

(51) Int. Cl. G06Q 30/02

(52) U.S. Cl. CPC G06Q 30/0206
USPC 705/7.35

(57) ABSTRACT

Provided is a system for estimating price sensitivities and determining aggregate price adjustments for a population of items, the population comprising a plurality of sub-populations. More specifically, provided is a system comprising a computer executing a price sensitivity engine and a price aggregation engine, the price sensitivity engine receiving time-series information, determining covariate coefficients to estimate a population price sensitivity average, modeling a first set of vectors based on the covariate coefficients, modeling a second set of vectors based on the covariate coefficients and an indicator variable, and estimating sub-population price sensitivities based on the first and second sets of vectors; and the price aggregation engine comparing each of the sub-population price sensitivities to the population price sensitivity average and/or to other sub-population price sensitivities, ranking, ordering, and/or clustering the sub-populations, and determining aggregate price adjustments to items in the sub-populations.

### CROSS-REFERENCE TO RELATED APPLICATIONS

This application claims priority under 35 U.S.C. §119(e) to U.S. Provisional Patent Application No. 61/779,717, filed Mar. 13, 2013, the entire disclosure of which is expressly incorporated herein by reference.

### BACKGROUND OF THE INVENTION

1. Field of the Invention

The present invention relates generally to a system and method for estimating price sensitivity, and more particularly, estimating price sensitivity for a collection of items in sub-populations of a population, wherein the estimated price sensitivity of the sub-populations can be used for price aggregation.

2. Related Art

Price aggregation is typically used to apply the same percentage price changes to a large collection of items/products (e.g. all the SKUs in a retail store or in a department of a store). Price aggregation is a common pricing technique due to the operational ease of execution. For example, for an operational perspective it is generally more efficient to apply the same discount to a collection of items than to each individual item.

A common practice among retailers trying to improve margins is to create virtual pricing zones for their stores. For example, stores located in profitable tourist locations typically exhibit less price sensitivity (i.e. the influence of the price of the product on consumer behavior) and can thus be placed in higher pricing tier zones. To minimize operational costs, some retailers often apply the same percentage price increase across all items in a store or in an entire store department, sometimes consisting of thousands of different items. This seemingly crude price change execution can lead to surprisingly good results if done properly. In this situation, the problem is typically not finding the price elasticity of an individual item, but rather is typically finding the price sensitivity of, for example, an entire store of many items and how it compares to other stores.

Conventional approaches to price aggregation have typically employed a traditional bottom-up approach for which standard econometric theory is applied at an individual item level to derive price elasticity for each individual item. In this conventional approach, an overall population price sensitivity is typically derived based on a weighted aggregation of the price elasticity for each item. The conventional approach to price aggregation can be inadequate for modeling individual items when the point-of-sale data is sparse and/or cyclical and/or when the individual items have a short life cycle and/or low price variation. In most retail environments, and particularly for non-commodities, utilizing such a bottom-up approach typically manages to correctly model about ten percent (10%) of spend, on average, for a retail store. As a result, any subsequent price analysis/recommendations on an aggregate level can be difficult, inefficient, and/or inappropriate.

### SUMMARY OF THE INVENTION

The present invention relates to a system and method for estimating price sensitivity for one or more sub-populations of a populations, where each sub-populations includes a collection of items, e.g. an entire store or department of a store. The price sensitivity of the sub-population can be compared and/or clustered together with other sub-populations of similar price sensitivity.

In exemplary embodiments, price aggregation can be performed based on the estimated price sensitivity of the sub-populations.

Exemplary embodiments of the present disclosure can utilize a variation of Generalized Linear Models (GLMs) called Generalized Estimating Equations (GEEs) that can be applied in a top-down fashion and can model an overall store-to-store or department-to-department sensitivity comparison. In exemplary embodiments GEEs can allow for non-normal distribution assumptions and can take into account the internal correlation structure of time series sales data for each item, even when there is sparse data for one or more items.

As described herein, exemplary embodiments of the present disclosure can advantageously produce price sensitivity estimates on any aggregation level of a product hierarchy, which can be determined, for example, by the level at which price change execution is performed (e.g., regional level, store level, department level, etc.).

### BRIEF DESCRIPTION OF THE DRAWINGS

The foregoing features of the invention will be apparent from the following Detailed Description of the Invention, taken in connection with the accompanying drawings, in which:

FIG. 1 is a block diagram of an exemplary price modifier that includes a price sensitivity engine and a price aggregation engine in accordance with exemplary embodiments of the present disclosure;

FIG. 2 is a flowchart showing overall processing steps carried out by an exemplary embodiment of the price sensitivity process;

FIG. 3 is a flowchart showing overall processing steps carried out by an exemplary embodiment of the price adjustment process;

FIG. 4 is a diagram showing hardware and software components of an exemplary system of the present disclosure;

### DETAILED DESCRIPTION OF THE INVENTION

The present invention relates to a system and method for estimating price sensitivity for one or more sub-populations of a population, where each sub-population includes a collection of items, e.g. an entire store or department of a store, as discussed in detail below in connection with FIGS. 1-4. In exemplary embodiments of the present disclosure, the price sensitivity of the sub-populations can be compared and/or clustered together with other sub-populations of similar price sensitivity and/or price aggregation can be performed based on the estimated price sensitivity of the sub-populations.

Exemplary embodiments of the present disclosure can utilize a variation of Generalized Linear Models (GLMs) called Generalized Estimating Equations (GEEs) that can be applied in a top-down fashion and can model an overall store-to-store or department-to-department price sensitivity comparison. In exemplary embodiments GEEs can allow for non-normal distribution assumptions and can take into account the internal correlation structure of time series data for each item, even when there is sparse data for one or more items. Thus, the present disclosure deals seamlessly with missing values in time-series data.

FIG. 1 is a block diagram of an exemplary embodiment of price modifier 100 that includes a price sensitivity engine 110 and a price aggregation engine 120 in accordance with the present system. The engine 110 can be programmed and/or configured to implement a price sensitivity process 112 and/or the engine 120 can be programmed and/or configured to implement a price aggregation process 122. The price sensitivity process 112 executed by the engine 110 can estimate the price sensitivity for a collection of items in a sub-population and/or the price aggregation process 122 executed by the engine 120 can collectively adjust the prices of items in the sub-population based on the estimated price sensitivity of the sub-population. While engines 110 and 120 have been shown as separate software-based engines, those skilled in the art will recognize that the engines 110 and 120 can be implemented as a single engine.

In exemplary embodiments, the engine 110 can be programmed and/or coded to implement a price sensitivity model 114. The model 114 can use a variation of Generalized Linear Models (GLMs) referred to Generalized Estimating Equations (GEEs) to collectively estimate the price sensitivity for items in an overall population (e.g., a large aggregation of items). The GEEs utilized in the model 114 utilized by the engine 110 can allow for non-normal distribution assumptions and can take into account an internal correlation structure of time series data 116 for each item, while addressing data sparsity.

The engine 110 can receive the time-series data 116 from one or more data sources (e.g., databases). The time series data 116 can include information about items in a sub-population. For example, the time series data for each item can include a quantity sold (Q), average price (P), competitor prices, promotions-related variables, seasonal indicators, trend data with time for Q and/or P, and/or any other suitable information that can be used to determine the collective price sensitivity of a sub-population.

The GEEs implemented in the model 114 utilized by the engine 110 can be configured for price sensitivity modeling by defining a repeated measure to be an item for which, at each discrete time period in a time-series, the quantity sold (Q) and the average price (P) are measured. In some embodiments, competitor prices, promotions-related variables, seasonal indicators, trend data with time for Q and/or P, and/or any other suitable information can be used to improve the fit of the price sensitivity model. The price sensitivity model can be constructed such that Q is the response variable, and P and other information can be covariates. An appropriate correlated structure can be defined and imposed on the time series sales data for an item.

Exemplary embodiments of the engine 110 allow for specifying the repeated measure—Q in every time period and allows for specifying a list of covariates describing the sales quantity in the given time period including, but not limited to, Price (P), competitor prices, promotions-related variables, seasonal indicators, trend data with time for Q and/or P, and/or any other suitable information that can be used to determine the collective price sensitivity of a sub-population. Further, the engine 110 allows for specifying a non-normal Poisson-type distribution of the response variable Q, which is appropriate given that Q is a positive count variable and not a continuous normally distributed one.

The engine 110 can implement a link function on the response variable Q. For example, a log-link function can be implemented that provides the relationship between the linear predictor and a mean of a distribution function, which following econometric theory, models price elasticity in a given logQ/logP relationship. In some embodiments, the engine 110 allows for specifying an internal correlation structure of the time series data 114 of each item and thus allows for modeling entire vectors of observations as opposed to individual scalar data points.

The entire input longitudinal data can be a grand population and aggregate entities (sub-populations) can be identified for which the engine 110 estimates price sensitivity for subsequent comparison to other sub-populations. Sub-population price sensitivity estimates can be used for rank ordering, clustering, and/or aggregate price adjustments. For example, embodiments the engine 110 can output price sensitivity estimates to the engine 120 to perform aggregate price adjustments on items in selected sub-populations.

The engine 120 can be programmed and/or configured to receive the price sensitivity estimates generated by the engine 110 and can use the price sensitivity estimates to perform aggregate price adjustments to a collection of items in a sub-population. In one exemplary embodiment, the engine 120 can be programmed and/or configured to compare the price sensitivity of a sub-population to the entire population and to other sub-populations to determine its relative price sensitivity. For example, in some embodiments, the engine 120 can be programmed to rank, order, or cluster populations with like price sensitivity estimates and can be programmed to apply aggregate price adjustments to items based on the rank, order, or cluster association of a population. The price sensitivity estimates can be ranked, ordered, and/or clustered by the engine 120 by setting the entire population average to zero (0). A positive price sensitivity estimate of a sub-population can indicate that the sub-population is less price-sensitive than the entire population. A negative estimate of a sub-population can indicate that the sub-population is more price-sensitive than the entire population. The sub-population price sensitivity estimates can be directly comparable among each other. The engine 120 could provide directional guidance as to how prices for a cluster of sub-populations should increase or decrease relative to other clusters of sub-populations, without specifying an exact amount (e.g., a percentage amount) of such increase or decrease. Thus, if it is established that the price for one cluster of subpopulations can increase by 5%, then the engine 120 can determine, based on comparing the rank-ordering price sensitivity coefficients, that the price for another, less price-sensitive cluster of subpopulations can increase by 7%, and that the price for yet another, even less price-sensitive cluster of subpopulations can increase by 9%.

Using the relative price sensitivity of the sub-populations, the engine 120 can be programmed to assign a price adjustment to the items in the sub-population. For example, is the engine 120 determines that the price sensitivity of a sub-population is negative compared to the entire population, but is not as negative as other sub-populations, a price reduction can be applied to the items in the sub-population and the price reduction can be less than the price reduction applied to other sub-populations having a price sensitivity that is more negative than the sub-population.

FIG. 2 is a flowchart showing overall processing steps 200 of an exemplary embodiment of the price sensitivity process 112 carried out by the engine 110 of the present disclosure. Beginning in step 202, point-of-sale time series data and/or other time series data is obtained for the items in a specified population for a specified period of time. In step 204, a population average is computed, which can be expressed by a set of coefficients for each covariate defined in the model 114, and in step 206, the population coefficients (e.g., covariate coefficients) can be stored. In step 208, vectors of the sales data points of the items are modeled. The modeling can take into account inter-correlation between the covariates and can take into account a non-normality assumption for the response variables.

In step 210, an indicator variable (or dummy variable) for sub-populations of the specified population can be added to the model and in step 212, the model can be re-run with fixed population covariate coefficients computed in step 206. In step 214, price sensitivity estimates can be computed for each sub-population.

FIG. 3 is a flowchart showing overall processing steps 300 of an exemplary embodiment of the price adjustment process 122 carried out by the engine 120 of the present disclosure. Beginning in step 302, price sensitivity estimates for one or more sub-populations are received by the engine 120. In step 304, the engine 120 programmatically compares the price sensitivities of the sub-populations. In step 306, the sub-populations can be ranked, ordered, and/or clustered based on the comparison performed in step 304. Using the rank, order, and/or cluster association of the sub-populations, in step 308, the engine 120 can apply aggregate price adjustments to the items in one or more sub-populations. The aggregate price adjustments can be a percent and/or monetary increase or decrease in the price applied collectively to the items in the one or more sub-populations. The aggregate price adjustments for the sub-populations can be different based on the price sensitivity estimate associated with each sub-population.

As described herein, exemplary embodiments of the present disclosure can be used to produce price sensitivity estimates on any aggregation level of a product hierarchy. For example, using an exemplary of the present disclosure, price sensitivity estimates can be estimated for an entire chain of stores in a geographical location, a single store, a department within a store, class/subclass within a store, and/or at any other suitable level of a product hierarchy. The appropriate level can be determined, for example, by the level at which price change execution is performed. For example, if price changes are executed on a department level (all items in a given department receive the same percent change in price) within a virtual pricing zone of stores, then the entire population would comprise all stores and the sub-population would be the items within a department in each store and price sensitivity estimates can be computed for each department for each store. A vector of department price sensitivity estimates can be defined based on the price sensitivity estimates to represent each store and stores can be clustered together into pricing zones based on similarity of price sensitivity of individual departments. Price changes can be executed on a department level within a pricing zone—all items within a given department get the same price change across all stores in a virtual pricing zone.

FIG. 4 is a diagram showing hardware and software components of an exemplary system 400 capable of performing the processes discussed above. The system 400 includes a processing server 402, e.g., a computer, and the like, which can include a storage device 404, a network interface 408, a communications bus 416, a central processing unit (CPU) 410, e.g., a microprocessor, and the like, a random access memory (RAM) 412, and one or more input devices 414, e.g., a keyboard, a mouse, and the like. The processing server 402 can also include a display, e.g., a liquid crystal display (LCD), a cathode ray tube (CRT), and the like. The storage device 404 can include any suitable, computer-readable storage medium, e.g., a disk, non-volatile memory, read-only memory (ROM), erasable programmable ROM (EPROM), electrically-erasable programmable ROM (EEPROM), flash memory, field-programmable gate array (FPGA), and the like. The processing server 402 can be, e.g., a networked computer system, a personal computer, a smart phone, a tablet, and the like.

In exemplary embodiments, the price modifier 100, or portions thereof, can be embodied as computer-readable program code stored on one or more non-transitory computer-readable storage device 404 and can be executed by the CPU 410 using any suitable, high or low level computing language, such as, e.g., Java, C, C++, C#, .NET, and the like. Execution of the computer-readable code by the CPU 410 can cause the price modifier 100 to implement embodiment of the price sensitivity process 112 and/or price adjustment process 122. The network interface 408 can include, e.g., an Ethernet network interface device, a wireless network interface device, any other suitable device which permits the processing server 402 to communicate via the network, and the like. The CPU 410 can include any suitable single- or multiple-core microprocessor of any suitable architecture that is capable of implementing and/or running the price modifier 100, e.g., an Intel processor, and the like. The random access memory 412 can include any suitable, high-speed, random access memory typical of most modern computers, such as, e.g., dynamic RAM (DRAM), and the like.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention. What is desired to be protected by Letters Patent is set forth in the following claims.

What is claimed is:

1. A system for estimating price sensitivities and determining aggregate price adjustments for a population having a collection of items, the system comprising:
a computer system in electronic communication with a database storing time-series information therein, the computer system executing a price sensitivity engine and a price aggregation engine, said price sensitivity engine performing the steps of:
electronically receiving from the database the time-series information;
determining, based on the time-series information, a set of covariate coefficients to estimate a population price sensitivity average for the collection of items, the population comprising a plurality of sub-populations;
modeling for the collection of items a first set of vectors based on the covariate coefficients;
modeling for the collection of items a second set of vectors based on the covariate coefficients and an indicator variable; and
estimating a sub-population price sensitivity for each of the plurality of sub-populations based on the first set of vectors and the second set of vectors, to generate a plurality of sub-population price sensitivities; and
said price aggregation engine performing the steps of:
comparing each of the sub-population price sensitivities to at least one of the population price sensitivity average or other sub-population price sensitivities of the plurality of sub-population price sensitivities;
based on said comparing, at least one of ranking, ordering, or clustering the plurality of sub-populations; and
determining aggregate price adjustments for items in one or more of the plurality of sub-populations based on the at least one of ranking, ordering or clustering.

2. The system of claim 1, wherein the time-series data includes information relating to at least one of a quantity of items sold, an average price of items sold, competitor prices, promotions-related variables, seasonal indicators, or trend data.

3. The system of claim 1, wherein the price aggregation engine further performs the step of adjusting prices for the items in the one or more of the plurality of sub-populations based on the determined aggregate price adjustments.

4. The system of claim 1, wherein the price sensitivity engine performs the comparing step by setting the population price sensitivity average to zero (0), wherein a positive price sensitivity estimate of a sub-population indicates that the sub-population is less price sensitive than the population, and a negative price sensitivity estimate of a sub-population indicates that the sub-population is more price sensitive than the population.

5. The system of claim 1, wherein the price sensitivity engine models at least one of the first set of vectors or the second set of vectors based on a non-normal Poisson-type distribution for a quantity of items of sold for a given time period.

6. The system of claim 1, wherein the applying aggregate price adjustments comprises applying a percentage and/or monetary increase or decrease in price applied collectively to the items in the one or more of the plurality of sub-populations.

7. The system of claim 1, wherein the population is a plurality of stores, and each sub-population is a department within each of the plurality of stores.

8. The system of claim 7, wherein the price aggregation engine clusters the plurality of departments to determine a first set of stores in a first virtual pricing zone and a second set of stores in a second virtual pricing zone.

9. The system of claim 8, wherein the applying aggregate price adjustments comprises adjusting by a first amount prices of all items within the department for the first set of stores, and adjusting by a second amount prices of all items within the department for the second set of stores.

10. A method for estimating price sensitivity and generating aggregate price adjustments for a population having a collection of items, comprising the steps of:
electronically receiving, by a price sensitivity engine of a computer system, time-series information from a database in electronic communication with the computer system;
determining, by the price sensitivity engine, a set of covariate coefficients based on the time-series information to estimate a population price sensitivity average for the collection of items, the population comprising a plurality of sub-populations;
modeling, by the price sensitivity engine, a first set of vectors for the collection of items based on the covariate coefficients;
modeling, by the price sensitivity engine, a second set of vectors for the collection of items based on the covariate coefficients and an indicator variable;
estimating, by the price sensitivity engine, a sub-population price sensitivity for each of the plurality of sub-populations based on the first set of vectors and the second set of vectors, to generate a plurality of sub-population price sensitivities;
comparing, by a price aggregation engine of the computer system, each of the sub-population price sensitivities to at least one of the population price sensitivity average or other sub-population price sensitivities of the plurality of sub-population price sensitivities;
at least one of ranking, ordering, or clustering, by the price aggregation engine, the plurality of sub-populations based on the comparing; and
determining, by the price aggregation engine, aggregate price adjustments for items in one or more of the plurality of sub-populations based on the at least one of ranking, ordering or clustering.

11. The method of claim 10, wherein the time-series data includes information relating to at least one of a quantity of items sold, an average price of items sold, competitor prices, promotions-related variables, seasonal indicators, or trend data.

12. The method of claim 10, further comprising the step of adjusting, by the price aggregation engine, prices for the items in the one or more of the plurality of sub-populations based on the determined aggregate price adjustments.

13. The method of claim 10, wherein the price sensitivity engine performs the comparing step by setting the population price sensitivity average to zero (0), wherein a positive price sensitivity estimate of a sub-population indicates that the sub-population is less price sensitive than the population, and a negative price sensitivity estimate of a sub-population indicates that the sub-population is more price sensitive than the population.

14. The method of claim 10, wherein the price sensitivity engine models at least one of the first set of vectors or the second set of vectors based on a non-normal Poisson-type distribution for a quantity of items of sold for a given time period.

15. The method of claim 10, wherein the applying aggregate price adjustments comprises applying a percentage and/or monetary increase or decrease in price applied collectively to the items in the one or more of the plurality of sub-populations.

16. The method of claim 10, wherein the population is a plurality of stores, and each sub-population is a department within each of the plurality of stores.

17. The method of claim 16, wherein the price aggregation engine clusters the plurality of departments to determine a first set of stores in a first virtual pricing zone and a second set of stores in a second virtual pricing zone.

18. The method of claim 17, wherein the applying aggregate price adjustments comprises adjusting by a first amount prices of all items within the department for the first set of stores, and adjusting by a second amount prices of all items within the department for the second set of stores.

19. A computer-readable medium having computer-readable instructions stored thereon which, when executed by a computer system comprising a price sensitivity engine and a price aggregation engine, cause the computer system to perform the steps of:
electronically receiving, by the price sensitivity engine, time-series information from a database in electronic communication with the computer system;
determining, by the price sensitivity engine, a set of covariate coefficients based on the time-series information to estimate a population price sensitivity average for the collection of items, the population comprising a plurality of sub-populations;
modeling, by the price sensitivity engine, a first set of vectors for the collection of items based on the covariate coefficients;
modeling, by the price sensitivity engine, a second set of vectors for the collection of items based on the covariate coefficients and an indicator variable;
estimating, by the price sensitivity engine, a sub-population price sensitivity for each of the plurality of sub-populations based on the first set of vectors and the second set of vectors, to generate a plurality of sub-population price sensitivities;
comparing, by the price aggregation engine, each of the sub-population price sensitivities to at least one of the population price sensitivity average or to other sub-population price sensitivities of the plurality of sub-population price sensitivities;
at least one of ranking, ordering, or clustering, by the price aggregation engine, the plurality of sub-populations based on the comparing; and
determining, by the price aggregation engine, aggregate price adjustments for items in one or more of the plurality of sub-populations based on the at least one of ranking, ordering or clustering.

20. The computer-readable medium of claim 19, wherein the time-series data includes information relating to at least one of a quantity of items sold, an average price of items sold, competitor prices, promotions-related variables, seasonal indicators, or trend data.

21. The computer-readable medium of claim 19, causing the computer system to further perform the step of adjusting, by the price aggregation engine, prices for the items in the one or more of the plurality of sub-populations based on the determined aggregate price adjustments.

22. The computer-readable medium of claim 19, wherein the price sensitivity engine performs the comparing step by setting the population price sensitivity average to zero (0), wherein a positive price sensitivity estimate of a sub-population indicates that the sub-population is less price sensitive than the population, and a negative price sensitivity estimate of a sub-population indicates that the sub-population is more price sensitive than the population.

23. The computer-readable medium of claim 19, wherein the price sensitivity engine models at least one of the first set of vectors or the second set of vectors based on a non-normal Poisson-type distribution for a quantity of items of sold for a given time period.

24. The computer-readable medium of claim 19, wherein the applying aggregate price adjustments comprises applying a percentage and/or monetary increase or decrease in price applied collectively to the items in the one or more of the plurality of sub-populations.

25. The computer-readable medium of claim 19, wherein the population is a plurality of stores, and each sub-population is a department within each of the plurality of stores.

26. The computer-readable medium of claim 25, wherein the price aggregation engine clusters the plurality of departments to determine a first set of stores in a first virtual pricing zone and a second set of stores in a second virtual pricing zone.

27. The method of claim 26, wherein the applying aggregate price adjustments comprises adjusting by a first amount prices of all items within the department for the first set of stores, and adjusting by a second amount prices of all items within the department for the second set of stores.
